(19) United States
(12) Patent Application Publication
(10) Pub. No.: US 2025/0305475 A1
(43) Pub. Date: Oct. 2, 2025

(54) Water current and movement energy harvesting system for desalination and electricity production

(71) Applicants: Abdelhadi Begdouri, Repentigny (CA); Mohamed Serraj Andaloussi, Montreal (CA)

(72) Inventors: Abdelhadi Begdouri, Repentigny (CA); Mohamed Serraj Andaloussi, Montreal (CA)

(21) Appl. No.: 19/095,185

(22) Filed: Mar. 31, 2025

(30) Foreign Application Priority Data
Apr. 1, 2024 (GB) 2404635.1

(51) Int. Cl. F03B 17/06; F03B 3/12; F03B 11/00

(52) U.S. Cl. CPC F03B 17/06; F03B 3/12; F03B 11/00; F05B 2220/706; F05B 2240/212; F05B 2240/213; F05B 2240/214; F05B 2240/93

(57) ABSTRACT

A water current and movement energy harvesting system for desalination and electricity production, has a floating platform, a plurality of submerged spherical frame platforms connected to the floating platform, each spherical frame platform has a plurality of vertical axis turbines (VATs) of different sizes arranged to maximize exposure to water movement and minimize interference. Integrated pumps for transferring seawater to a pressurized seawater tank. Buoyancy tank for adjusting the depth of the spherical frame platform. The pressurized seawater is transferred from the spherical frame platforms to the floating platform to drive hydraulic motors coupled to electrical generators and to be pushed through reverse osmosis filters for desalination, and the generated electricity and fresh water are transferred to shore for further processing and distribution. Also, the water can be turned into hydrogen and oxygen by electrolysis and water can also be used to cool data centers.

### CROSS-REFERENCE TO RELATED APPLICATIONS

The present application claims priority to UK request application number GB2404635.1, filed on Apr. 1, 2024 the disclosure of which is hereby incorporated in its entirety at least by reference.

### BACKGROUND OF THE INVENTION

### 1. Field of the Invention

The present invention relates generally to systems for harnessing energy from water currents and movements, but more particularly to a water current and movement energy harvesting system for desalination and electricity production, hydrogen, oxygen generation, and heat dissipation.

### 2. Description of Related Art

The harnessing of wind or water energy as a way to move components to do work has been known for centuries. Since the 19^{th} century, generators and dynamos have been used to produce electricity from the force of air and water. It should come as no surprise that there are tens of thousands of patents related to the harnessing of those natural forces.

Here is but a small sampling of energy producing devices using water:

Patent application US Patent Application 20120224968 describes a vertical axis turbine includes a modified Darrius type rotor having at least three circumferentially spaced apart blades, each having an airfoil shape in cross section such that the blades generate a torque in a direction of rotation of the turbine about the vertical axis responsive to a generally horizontal wind across the blades. Support members, for example flexible cables, are connected under tension between adjacent ones of the blades to extend in a generally circumferential direction about the turbine at an inclination from horizontal in a criss-crossing pattern with other support members. A tensioning mechanism also urges opposing top and bottom ends of the rotor towards one another such that the blades are supported under compression in a pre-stressed condition by the support members and the tensioning mechanism to maintain the blades in a substantially rigid and fixed orientation throughout the operation of the turbine rotor.

U.S. Pat. No. 4,748,808 describes a fluid powered motor-generator that includes a generator having a power output and a mechanically driven input. A generally streamlined motor body is rotatably mounted to drive the generator input and includes a plurality of radially extending generally V-shaped fins mounted on an outside surface thereof. The fins are mounted on brackets above an outer surface of the motor body and have a convex pointed side facing in the direction of rotation and a concave open side facing in a direction opposite to the direction of rotation. Thus, the action of a stream of fluid on the fins tends to rotate the motor body and drive the generator. If the motor-generator apparatus is mounted in water, the generator can be enclosed in another streamlined body which is anchored to the bed of the body of water. A third streamlined motor body can be attached to the bottom of the generator body with a plurality of radially extending fins oriented to cause it to rotate opposite to the direction of rotation of the first streamlined motor body.

When it comes to using the force of water to desalinate salty water, U.S. Pat. No. 6,083,382 describes a system and method for producing potable water from a brine source using an Archimedean screw to elevate water to an elevated point. The water is then filtered to desalinate the water through a series of filters arranged in a vertical shaft using gravity to move the water through the filters. The vertical nature of the screw and shaft reduce land requirements and costs. A power source turns the screw and relies on renewable energy sources, such as solar, wind, and tidal/wave power. A turbine is used to recapture any energy in the descending water. The screw, renewable energy power source, and turbine reduce the energy requirements and costs. A brine recycling system recovers the removed brine and various elements and minerals are separated.

US Patent Application 20050271501 describes a submersible power plant using a submersible enclosure having at least one intake valve for admitting water at high pressure from the surrounding sea into an air space in the enclosure. An air shaft from the air space is in communication with the atmosphere for maintaining the air space at approximately one atmosphere. A pump for evacuating water collected in the enclosure includes a buoy responsive to ocean swells. A piston shaft connected to the buoy reciprocates in the center bore of a vertical column extending upward from the bottom of the enclosure. As the piston shaft rises inflow valves admit water in the enclosure into a valve housing in communication with the center bore. As the piston shaft falls water is discharged from the valve housing into the sea through a discharge valve in the bottom of the enclosure.

US Patent Application 2006232075 describes a support structure for a flowing-water driveable turbine system, wherein a turbine, or a plurality of turbine assemblies are mounted for operational co-operation with a flow of water on a deck or platform of streamlined cross-section in such a manner that the turbines are deployed laterally i.e. normal to the direction of flow across the current and wherein the deck or platform is aligned horizontally with the current so as to minimise its resistance to the water flow, deck or platform being is either being supported in the elevated position by at least two supporting legs or struts upstanding from the bed of said flowing water or is buoyant and held down in the water column by tensioned cables, ropes or ties anchored to the sea, river or estuary bed to be at said elevated location.

US Patent Application 20110131970 describes a power generating apparatus comprising a first arrangement comprising a first buoyancy vessel configured to float at a surface of a body of water, the first arrangement comprising at least one energy conversion apparatus operable to be driven by the environment. The power generating apparatus also comprises a second arrangement permanently moored to the bed of the body of water, the second arrangement comprising: a second buoyancy vessel configured to be neutrally buoyant at a location in the body of water spaced apart from the bed of the body of water; and an electrical cable. The first and second arrangements are configured for releasable attachment to each other and such that electricity is conveyed through the electrical cable in dependence upon operation of the energy conversion apparatus when the first and second arrangements are attached to each other.

US Patent Application 20140140466 describes an offshore, manned, scalable, modular, floating, moored, nuclear power generating plant and multipurpose platform comprised of a Main Plant Control Deck, Central Plant Deck, and submerged Reactor-Generator Deck(s) integrated into the structure of a Spar or Cell Spar Platform. The Reactor-Generator decks are comprised of a plurality of modular, Naval Nuclear Pressurized Water Reactor Modules. Electricity generated is transmitted via submarine High Voltage Direct Current Cables to shore. Ancillary, co-generated services, e.g. desalinated water, are transmitted to shore via submarine pipelines. Multipurpose Topside Decks house vessel command, crew, and any ancillary and co-generation equipment. The present invention, constructed in a multi-path manufacturing process, provides exceptional economic, environmental, sustainability, security, safety, and operational advantages over the current art of power generation.

Russian Patent Application 2008110909 describes a method of producing fresh water by thermal decomposition of underwater gas hydrates of carbon dioxide (CO2), or hydrogen sulfide (H2S), or hydrocarbons (CH4 and CnH2n), released from the bowels of the earth, characterized in that its use is limited to the oceans and seas adjacent to the continental regions and islands with a deficit of fresh water, and the gas hydrates detected there are decomposed by direct exposure to their roof of natural surface sea water (warmer than bottom water) by pumping it through a boat lowered from the side of the boat to the bottom of the pipe.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for a water current and movement energy harvesting system for desalination and electricity production, hydrogen, oxygen generation, and heat dissipation.

In order to do so, the present invention provides for an integrated system that harnesses energy from water currents and movements to produce electricity and desalinate seawater. The same water action can also provide energy for the electrolysis of water in order to produce oxygen and hydrogen. Finally, the pumping of water can provide for the cooling of data centers.

The system for harnessing energy from water currents and movements has:

a. at least one submerged platform comprising a frame structure
b. a plurality of vertical axis turbines (VATs) mounted on the frame structure of the at least one submerged platform, said VATs configured to rotate in response to water currents and movements
c. at least one integrated pump mechanically coupled to at least one of the plurality of VATs, configured to pump seawater upon rotation of the coupled VAT
d. means for pressurizing the pumped seawater, operatively connected to receive seawater from the at least one integrated pump
e. a floating platform
f. at least one conduit fluidly connecting the means for pressurizing seawater on the at least one submerged platform to the floating platform, configured to transfer pressurized seawater
g. at least one hydraulic motor located on the floating platform, fluidly connected to the at least one conduit and configured to be driven by the transferred pressurized seawater; and
h. at least one electrical generator mechanically coupled to the at least one hydraulic motor, configured to produce electricity when driven by the hydraulic motor.

The system further comprises at least one reverse osmosis filter located on the floating platform, positioned fluidly downstream of the at least one hydraulic motor, and configured to receive seawater exiting the hydraulic motor to produce desalinated water.

In a preferred embodiment, the system has an electrolysis module located on the floating platform, electrically coupled to the at least one electrical generator and configured to utilize at least a portion of the produced electricity for electrolysis of water to generate hydrogen and oxygen.

In yet another embodiment, at least one pressure pump located on the floating platform, fluidly connected to receive a portion of the seawater and configured to supply said seawater as cooling water.

In still a further embodiment, the cooling water is supplied to a heat exchanger configured for cooling data centers.

The frame structure of the at least one submerged platform is a spherical frame structure.

In a preferred embodiment, the spherical frame structure comprises a combination of parallels and meridians or a geodesic structure.

The plurality of VATs comprises turbines of different sizes.

The plurality of VATs are arranged on the frame structure to maximize exposure to water movement while minimizing interference between adjacent VATs.

In some embodiments, the plurality of VATs are selected from the group consisting of H-rotor turbines, Savonius turbines, and Darrieus turbines.

The means for pressurizing the pumped seawater comprises at least one pressurized seawater tank located within the frame structure. The at least one pressurized seawater tank comprises a bellow separating the seawater from a compressed air volume, whereby seawater entering the tank compresses the air volume via the bellow.

The at least one submerged platform further comprises at least one buoyancy tank located in a base portion, configured to selectively adjust the buoyancy of the submerged platform. The system further comprises stabilization spikes coupled to the base portion and configured for anchoring the submerged platform to a seabed.

The plurality of submerged platforms are each fluidly connected to the floating platform via respective conduits.

The system has at least one power cable configured to transfer electricity generated by the at least one electrical generator from the floating platform to shore; and b. at least one fresh water pipe configured to transfer desalinated water produced by the at least one reverse osmosis filter from the floating platform to shore.

The system has a method for installing at least one submerged platform wherein the submerged platform has at least one buoyancy tank and stabilization spikes extending from a base portion, the method comprising the steps of:

a. positioning the at least one submerged platform at a desired installation location above a seabed while the at least one buoyancy tank contains sufficient gas to keep the platform buoyant;
b. introducing fluid into the at least one buoyancy tank to decrease the buoyancy of the submerged platform;
c. allowing the submerged platform to controllably sink towards the seabed due to the decreased buoyancy; and
d. continuing said sinking until the stabilization spikes penetrate and anchor the base portion into the seabed.

The system gas a method of operating the water current and movement energy harvesting wherein at least one submerged platform and a floating platform operatively connected, the method comprising the steps of:

a. exposing the at least one submerged platform to water currents or movements such as waves, tides, or sea currents;
b. rotating at least one vertical axis turbine (VAT) located on the at least one submerged platform in response to said water currents or movements;
c. actuating at least one integrated pump mechanically coupled to the at least one VAT by the rotation of the VAT;
d. pumping seawater using the actuated integrated pump and directing it to the means for pressurizing seawater located on the submerged platform;
e. transferring the pressurized seawater from the means for pressurizing on the submerged platform to the floating platform via the at least one conduit; and
f. utilizing the transferred pressurized seawater on the floating platform to perform at least one operation selected from the group consisting of: driving the at least one hydraulic motor to generate electricity via the coupled electrical generator, supplying a reverse osmosis filter for desalination, supplying an electrolysis module, and supplying a pressure pump (29) for cooling water.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 Schematic side elevational view of the invention in the context of use in a body of water.

FIG. 2A Cutaway side view of a spherical platform.

FIG. 2B Top view along line A-A.

FIGS. 3A-C Isometric views of various vertical turbine models, including an H-rotor, a Savonius, and a Darrieus.

FIG. 4 Top view of the floating platform, featuring the hydraulic motors, electrical generators, and reverse osmosis filters.

FIG. 5A Side view of the spherical platform.

FIG. 5B Top view of the spherical platform.

FIG. 6 Isometric view of the spherical platform.

FIG. 7 Side elevation of spikes used for stabilizing a sunken sphere.

FIG. 8 Schematic view of the key components of the system.

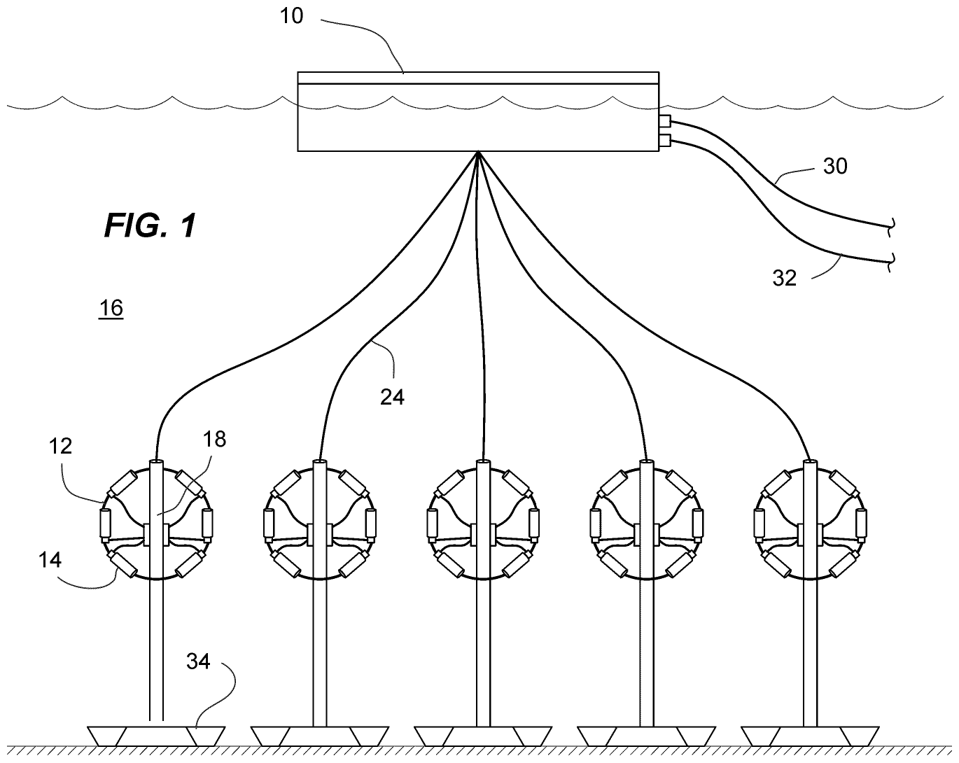

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

Referring now to any of the accompanying FIGURES, there is provided a water current and movement energy harvesting system designed to produce electricity for the desalination of seawater in turbulent ocean regions. The system comprises a floating platform 10 connected to multiple submerged spherical frame platforms 12.

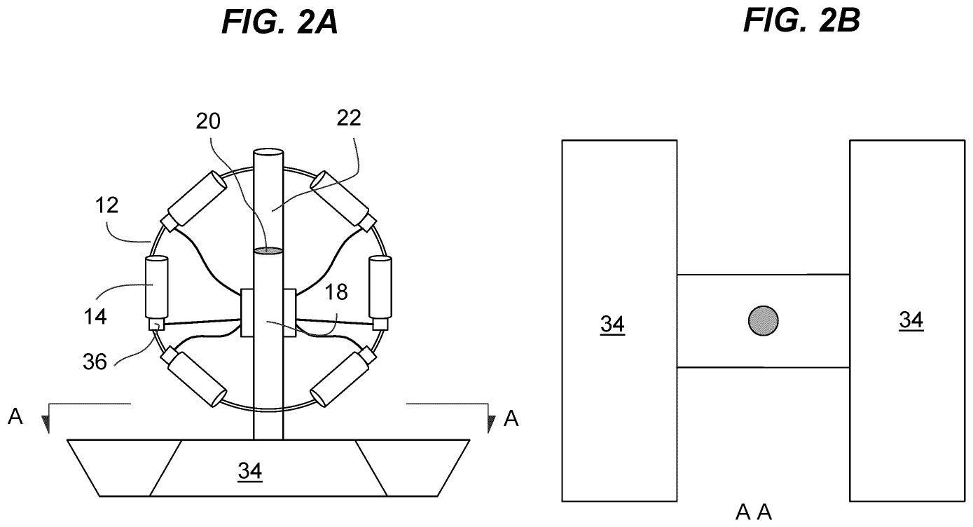

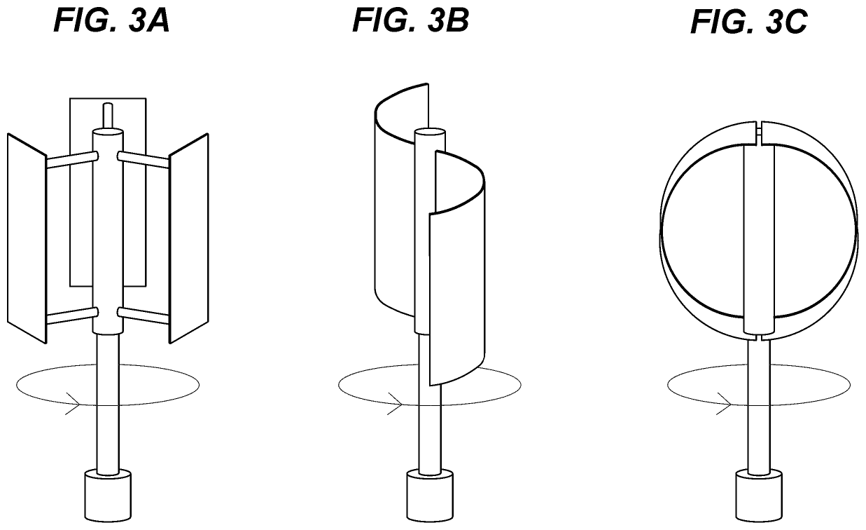

As shown in FIGS. 2A and 2B, each spherical frame platform 12 is fitted with multiple vertical axis turbines (VATs) 14 of different sizes. The VATs 14 are arranged on the spherical frames 13 in a manner that maximizes their exposure to water movement from any direction while minimizing interference between adjacent VATs 14. The spherical frame structure 13 can have a frame made of a combination of parallels and meridians, as shown in the figures, or as a geodesic frame structure. FIGS. 3A-C depicts three main variations of VATs 14: an H-rotor, a Savonius, and a Darrieus.

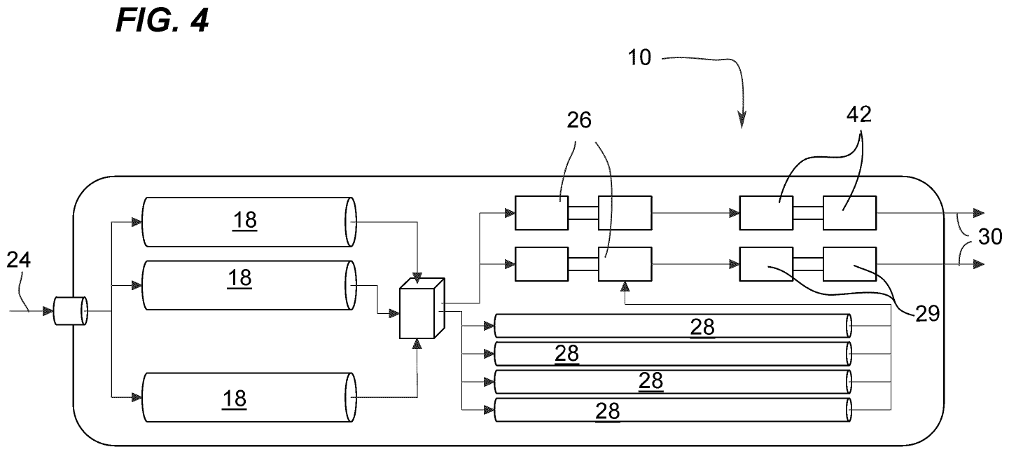

When the VATs 14 are actuated by water currents and movements, their integrated pumps 38 pump seawater 16 through feed pipes 40 into a pressurized seawater tank 18 located inside the spherical frames 12 (FIG. 4). The seawater tank 18 features a bellow 20, which creates pressure as the seawater pushes against it, compressing the air 22 behind the bellow 20. This principle, well-known in the art, is utilized in water pressure pumps. As a result, energy is stored in the form of water pressure. The pressurized seawater 16 is then transferred to the floating platform 10 via water hoses 24.

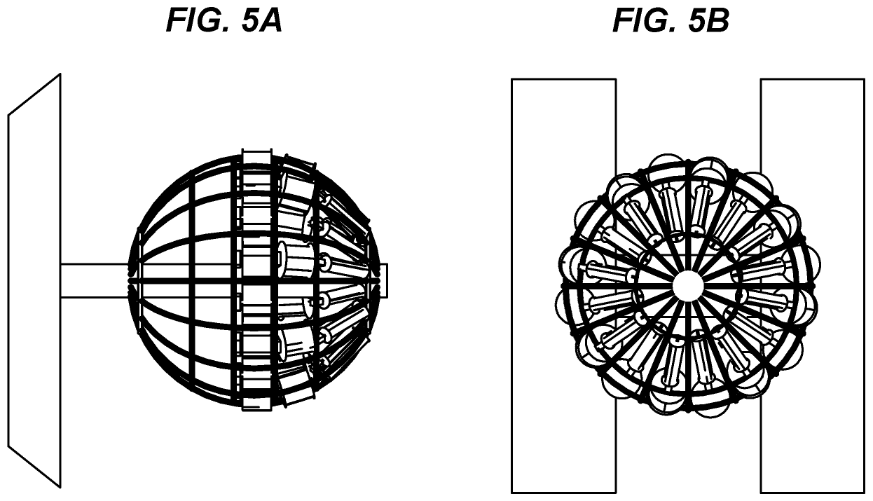

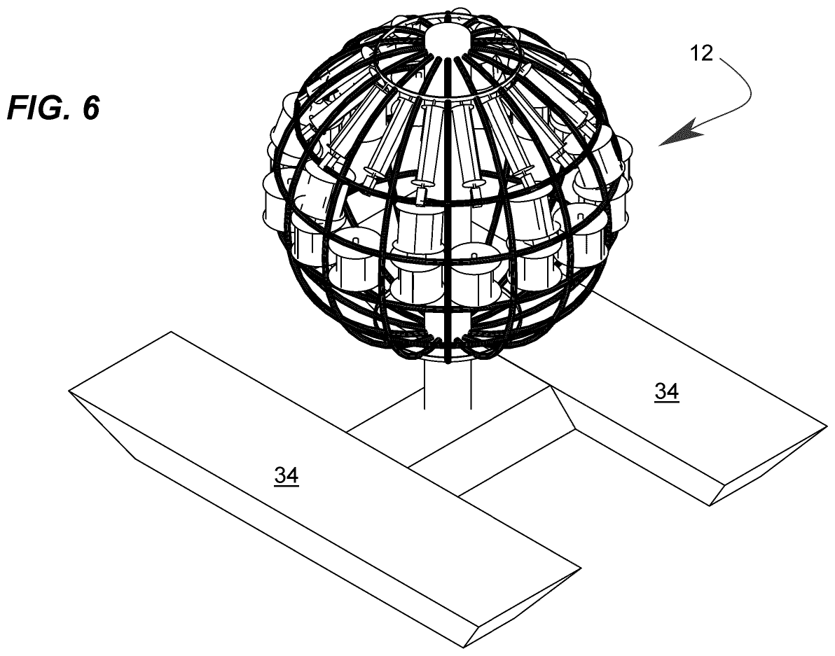

On the floating platform 10 (FIG. 5), the pressurized seawater 16 serves two purposes:

a. It drives hydraulic motors 26 coupled to electrical generators to produce electricity.
b. After passing through the hydraulic motors 26, the seawater is pushed through reverse osmosis filters 28 to desalinate the seawater 16 and produce fresh water 16′.

The generated electricity and fresh water 16′ are then transferred to shore using power cables 30 and fresh water pipes 32, respectively, for further processing and distribution.

Not all electricity is transferred offshore as some is used for the water electrolysis used in the production of oxygen and hydrogen. This process being well known does not need to be further elaborated, except to mention that the process would occur in an electrolysis module 42 located on the floating platform 10. The pumped water is also directed to pressure pumps 29 to provide cooling water for nearby data centers in a process well known in the art.

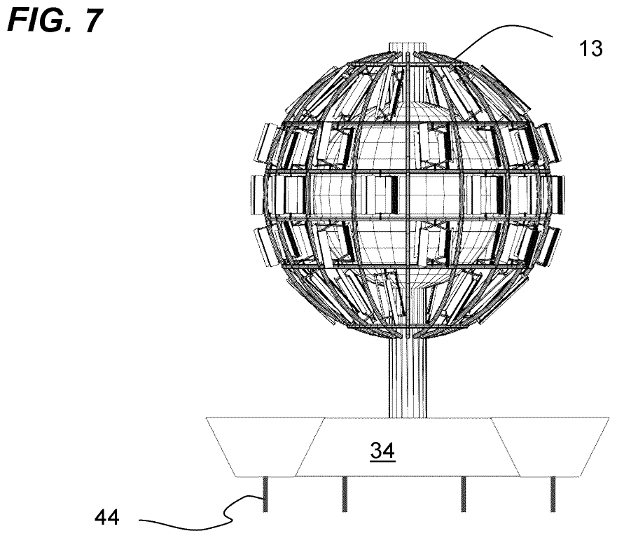

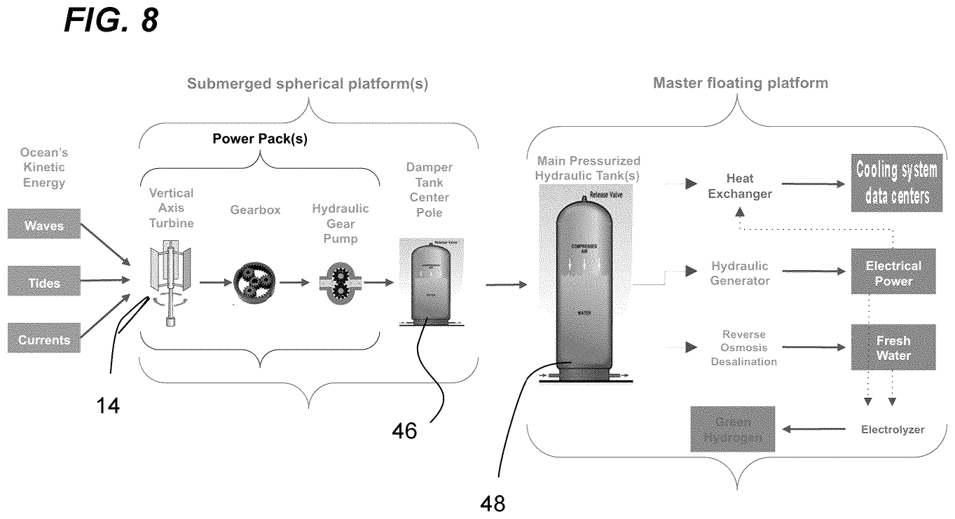

FIG. 7 shows the use of spikes planted into the seabed as a means to stabilize 44 the platform 10 to prevent it from sliding on the seabed when flow is intense. It should be remembered that the buoyancy tanks are hydrodynamic to facilitate the transport of the spheres on the surface of the water. That advantage becomes a liability once sunken to the bottom on the seabed.

As depicted in FIGS. 2A and 2B, the spherical frame platforms 12 also incorporate buoyancy tanks 34 located in a base portion 36. These buoyancy tanks 34 allow the spherical frames 12 to float or sink as needed during installation, maintenance, or relocation, eliminating the need for expensive lifting equipment and enhancing the system's flexibility and safety.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1. A system for harnessing energy from water currents and movements, the system comprising:
a. at least one submerged platform comprising a frame structure;
b. a plurality of vertical axis turbines (VATs) mounted on the frame structure of the at least one submerged platform, said VATs configured to rotate in response to water currents and movements;
c. at least one integrated pump mechanically coupled to at least one of the plurality of VATs, configured to pump seawater upon rotation of the coupled VAT;
d. means for pressurizing the pumped seawater, operatively connected to receive seawater from the at least one integrated pump;
e. a floating platform;
f. at least one conduit fluidly connecting the means for pressurizing seawater on the at least one submerged platform to the floating platform, configured to transfer pressurized seawater;
g. at least one hydraulic motor located on the floating platform, fluidly connected to the at least one conduit and configured to be driven by the transferred pressurized seawater; and
h. at least one electrical generator mechanically coupled to the at least one hydraulic motor, configured to produce electricity when driven by the hydraulic motor.

2. The system of claim 1, further comprising:
at least one reverse osmosis filter located on the floating platform, positioned fluidly downstream of the at least one hydraulic motor, and configured to receive seawater exiting the hydraulic motor to produce desalinated water.

3. The system of claim 1 further comprising:
an electrolysis module located on the floating platform, electrically coupled to the at least one electrical generator and configured to utilize at least a portion of the produced electricity for electrolysis of water to generate hydrogen and oxygen.

4. The system of claim 1 further comprising:
at least one pressure pump located on the floating platform, fluidly connected to receive a portion of the seawater and configured to supply said seawater as cooling water.

5. The system of claim 4, wherein the cooling water is supplied to a heat exchanger configured for cooling data centers.

6. The system of claim 1 wherein the frame structure of the at least one submerged platform is a spherical frame structure.

7. The system of claim 6, wherein the spherical frame structure comprises a combination of parallels and meridians or a geodesic structure.

8. The system of claim 1 wherein the plurality of VATs comprises turbines of different sizes.

9. The system of claim 1 wherein the plurality of VATs are arranged on the frame structure to maximize exposure to water movement while minimizing interference between adjacent VATs.

10. The system of claim 1 wherein the plurality of VATs are selected from the group consisting of H-rotor turbines, Savonius turbines, and Darrieus turbines.

11. The system of claim 1 wherein the means for pressurizing the pumped seawater comprises at least one pressurized seawater tank located within the frame structure.

12. The system of claim 11, wherein the at least one pressurized seawater tank comprises a bellow separating the seawater from a compressed air volume, whereby seawater entering the tank compresses the air volume via the bellow.

13. The system of any preceding claim, wherein the at least one submerged platform further comprises at least one buoyancy tank located in a base portion, configured to selectively adjust the buoyancy of the submerged platform.

14. The system of claim 13, further comprising stabilization spikes coupled to the base portion and configured for anchoring the submerged platform to a seabed.

15. The system of any preceding claim, comprising a plurality of submerged platforms, each fluidly connected to the floating platform via respective conduits.

16. The system of claim 2, further comprising:
a. at least one power cable configured to transfer electricity generated by the at least one electrical generator from the floating platform to shore; and
b. at least one fresh water pipe configured to transfer desalinated water produced by the at least one reverse osmosis filter from the floating platform to shore.

17. A method for installing at least one submerged platform of a water current energy harvesting system, the submerged platform comprising at least one buoyancy tank and stabilization spikes extending from a base portion, the method comprising the steps of:
a. positioning the at least one submerged platform at a desired installation location above a seabed while the at least one buoyancy tank contains sufficient gas to keep the platform buoyant;
b. introducing fluid into the at least one buoyancy tank to decrease the buoyancy of the submerged platform;
c. allowing the submerged platform to controllably sink towards the seabed due to the decreased buoyancy; and
d. continuing said sinking until the stabilization spikes penetrate and anchor the base portion into the seabed.

18. A method of operating the water current and movement energy harvesting system of claim 1, the system comprising at least one submerged platform (12) and a floating platform (10) operatively connected, the method comprising the steps of:
a. exposing the at least one submerged platform (12) to water currents or movements such as waves, tides, or sea currents;
b. rotating at least one vertical axis turbine (VAT) (14) located on the at least one submerged platform (12) in response to said water currents or movements;
c. actuating at least one integrated pump (38), mechanically coupled to the at least one VAT (14), by the rotation of the VAT (14);
d. pumping seawater (16) using the actuated integrated pump (38) and directing it to the means for pressurizing seawater located on the submerged platform (12);
e. transferring the pressurized seawater (16) from the means for pressurizing on the submerged platform (12) to the floating platform (10) via the at least one conduit (24); and
f. utilizing the transferred pressurized seawater (16) on the floating platform (10) to perform at least one operation selected from the group consisting of: driving the at least one hydraulic motor (26) to generate electricity via the coupled electrical generator, supplying a reverse osmosis filter (28) for desalination, supplying an electrolysis module (42), and supplying a pressure pump (29) for cooling water.
